(19) United States
(12) Patent Application Publication
(10) Pub. No.: US 2008/0170284 A1
(43) Pub. Date: Jul. 17, 2008

(54) Light Beam Scanner

(76) Inventor: Kenichi Hayashi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/791,803

(22) PCT Filed: Nov. 29, 2005
(86) PCT No.: PCT/JP2005/021896

§ 371 Date: Nov. 20, 2007

(30) Foreign Application Priority Data
Nov. 30, 2004 (JP) 2004-345403
Mar. 15, 2005 (JP) 2005-072834

(51) Int. Cl. G02B 26/12; G02B 26/10

(52) U.S. Cl. 359/216; 359/197; 359/209

(57) ABSTRACT

A light beam scanner (1a) comprises a light source device (10) for emitting a laser light of 880 nm and a light deflection mechanism (200) by which a light beam emitted from the light source device (10) is scanned with a light deflector over a predetermined range of angles; the light deflection mechanism (200) has a polygonal mirror (210) as the light deflector. The light source device (10) has a light-emitting source (20) composed of a laser diode and a lens (30) for guiding a light beam emitted from the light emitting device (20) as a converging light that focuses on or in the vicinity of a reflective surface (211) of the polygonal mirror (210) in at least one of the directions, the first direction or the second direction, which are perpendicular to the optical axis direction.

### TECHNICAL FIELD OF THE INVENTION

The present invention relates to a light beam scanner in which a light beam emitted from a light source device is scanned in a predetermined direction.

### TECHNICAL BACKGROUND

Light beam scanners have been widely used in image-forming devices such as laser printers, digital copy machines and fax machines, bar-code readers, or inter-vehicle distance measuring devices. In a light beam scanner used in an image-forming device, a light beam emitted from a laser LED such as a laser diode is periodically deflected by a polygonal mirror to repeatedly scan a surface to be scanned such as a photo sensitive body. In an inter-vehicle distance measuring device, a scan beam emitted by a light beam scanner is reflected on a body to be illuminated and the reflected beam is detected by a photo detector to detect information. At that time, the reflected beam is guided toward the photo detector at the angle of incidence corresponding to the scan angle of the polygonal mirror. Besides the method of rotating a polygonal mirror, another scan method may be used in which a light beam is scanned within a predetermined range of angles with the oscillation of the reflective plate.

A light beam irradiated on the polygonal mirror or reflective plate is a light emitted from the light source, in which the diverging power is reduced through a collimating lens to some extent. The dimension of the area on a polygonal mirror or reflective plate on which such a light is incident is equal to the effective diameter of the reflective surface on which the light beam is reflected. According to such an effective diameter, the size of the polygonal mirror or reflective plate is determined (for example, see Patent References 1, 2).

Note that in the light beam scanner an aperture stop is placed between the laser photo device and the collimating lens. Also, in the light beam scanner, pulsed light beams are irradiated synchronously with the scan angles.

Since the light beam incident on the polygonal mirror is fairly large in diameter in a conventional light beam scanner, the mirror needs to be larger than the beam diameter. For this reason, in the conventional light beam scanner, the polygonal mirror cannot be downsized, which prevents downsizing the light beam device and improving the productivity of the polygonal mirror. Also, forming a polygonal mirror by resin-mold can easily create a shrinkage cavity, making it difficult to improve productivity and yield. Further, when the polygonal mirror is driven by a motor, it is difficult to obtain a balance, degrading the jitter property.

Also proposed is a method of oscillating a reflective plate, in which, using a silicon micromachining process, [a reflective plate] is driven by electromagnetic force and electrostatic force produced by a silicon substrate and a torsion spring. Although this process is effective to refine regions, it is very expensive when dealing with a light beam having a larger beam diameter, and thus the advantage of using a super small reflective plate cannot be realized.

### [Patent Reference 1] Japanese Unexamined Patent Publication (Kokai) No. 11-014922

### [Patent Reference 2] Japanese Unexamined Patent Publication (Kokai) No. 11-326806

### DISCLOSURE OF THE INVENTION

Considering the above problems, an objective of the present invention is to provide a light beam scanner in which a light deflector such as a polygonal mirror can be downsized.

It is also to provide a light beam scanner that can be downsized smaller than a device using a polygonal mirror.

To achieve the above objects, the present invention features a light beam scanner having a light source device and a light deflection mechanism by which a light beam emitted from the light source device is scanned over a predetermined range of angles with a light deflector, wherein the light source device emits a converging light that focuses on or in the vicinity of the light deflector in at least one of the directions, the first direction or the second direction, which are perpendicular to the optical axis direction.

In the present invention, the light source device emits a converging light that focuses on or in the vicinity of the light deflector in at least one of the directions, the first direction or the second direction, which are perpendicular to the optical axis direction; therefore, the light deflector can be downsized in at least one of the directions, the first direction or the second direction. For this reason, productivity of the light deflector can be increased, and by using a state-of-the-art refining process a light deflector can be provided in which the number of scan points can be increased. Also, as the light deflector is downsized, the balance of the device while driven can be improved, enabling a highly precise light scan and downsizing of the drive mechanism such as a motor that drives the light deflector.

In the present invention, the light source device has a light-emitting source and a lens for guiding a light beam emitted from the light emitting source as a converging light that focuses on or in the vicinity of the light deflector in at least one of the directions, the first direction or the second direction, which are perpendicular to the optical axis direction.

In the present invention, the light emitting source is a laser LED, for example.

In the present invention, it is preferred that, when a light beam emitted from the light emitting source having diverging angles that are different in the first direction and the second direction enters the lens, the lens focus the light beam on or in the vicinity of the light deflector in at least the first or the second direction, in whichever the light beam diverges at a larger angle. In other words, when a light beam emitted from the light emitting source has an oval far-field pattern, it is preferred that the light in the direction of the major axis be converged; when a light beam is shaped by an aperture stop, it is preferred that the light in its major axis direction be converged. With this configuration, the light deflector can be downsized efficiently.

In the present invention, when a light beam having diverging angle that are different in the first direction and in the second direction enters the lens, the lens may focus the light beam emitted from the light emitting source on or in the vicinity of the light deflector in at least the first direction or the second direction, in whichever the light beam diverges at a smaller angle.

In the present invention, it is preferred that the lens guide the light beam emitted from the light emitting source as a converging light that focuses on or in the vicinity of the light deflector in both the first direction and the second direction. With this configuration, the light deflector can be downsized in both the first direction and the second direction.

In the present invention, it is preferred that the distance from the light emitting source to the focusing position of the converging light be 100 mm or less.

In the present invention, the lens is either an aspherical lens having a positive power, a toric lens, a toroidal lens or a cylindrical lens.

In the present invention, it is preferred that the lens have a curved surface having a positive power on the light-emitting source side and also have a plane on the light deflector side. If the light-exiting surface of the lens is a plane, the lens does not project toward the light-emitting surface of the light emitting device; therefore, when the light-emitting device is installed in the light beam scanner, the light-exiting surface of the lens will not be damaged.

In the present invention, the light source device may be equipped with a holder-type aperture stop having a recess portion between the light-emitting source and the lens, in which the light emitting source can be attached. In this case, it is preferred that the center position of the aperture opening of the holder-type aperture stop be coincided with the center position of the outside diameter of the holder-type aperture stop, and the center position of the recess portion be displaced from the center position of the outside diameter of the holder-type aperture stop by the dimension by which the center of the outside diameter of the portion of the light emitting source which is attached to the recess portion is displaced from the emitting point.

In the present invention, it is preferred that the lens and the aperture stop be coincided in the outer diameter dimension. With this configuration, the optical axis adjustment between the aperture stop and the lens can be easily carried out.

In the present invention, it is preferred that the lens be made of resin. When the light-emitting source emits pulsed light beams, heat generation will be very small; therefore, a resin lens can be used, which in turn reduces the manufacturing cost due to the use of a resin mold.

In the present invention, the light deflection mechanism may have a prism polygonal mirror as the light deflector and a drive mechanism for rotating the polygonal mirror about its axis.

In the present invention, when a polygonal mirror is used as the light deflector, it is preferred that a light incident on the polygonal mirror be the light beam that focuses on or in the vicinity of the polygonal mirror in a direction perpendicular to the center axis of rotation of the polygonal mirror. With this configuration, the light deflector can be downsized and a two-dimensional light scan can be carried out.

In the present invention, when a polygonal mirror is used as the light deflector, it is preferred that a light incident on the polygonal mirror be the light beam that focuses on or in the vicinity of the polygonal mirror in the directions which are both perpendicular to and parallel to the center axis of rotation of the polygonal mirror. With this configuration, the light deflector can be downsized and a one-dimensional light scan can also be carried out in addition to a two-dimensional light scan.

In the present invention, it is preferred that the light deflection mechanism have a light deflection disc as the light deflector and a rotation-drive mechanism for rotating the light deflection disc, a plurality of light deflection regions which are divisions in the circumferential direction be formed on a disc surface of the light deflection disc, and the plurality of light deflection regions guide incident light beams in directions different from the directions the adjacent light deflection regions guide. When a disc-like light deflector is used, the light beam scanner can be downsized and a shrinkage cavity will not be easily created even when the light deflector is manufactured by using a resin mold.

In the present invention, a transmitting light deflection disc can be used as the light deflection disc. In this case, on a disc surface of the transmitting light deflection disc, a plurality of light deflection regions are formed; and each of the plurality of light deflection regions has an inclined face which refracts an incident light beam in a direction different from the direction the adjacent light deflection region refracts the light, in order to guide an incident light beam in a direction different from the direction in which the adjacent light deflection region guides a light beam.

In the present invention, a reflective light deflection disc can be used as the light deflection disc. In this case, on a disc surface of the reflective light deflection disc, a plurality of light deflection regions which are divisions in the circumferential direction are formed; and each of the plurality of light deflection regions has an inclined face which reflects an incident light beam in a direction different from the direction in which the adjacent light deflection region reflects a light beam, in order to guide the incident light beam in a direction different from a direction in which the adjacent light deflection region guides a light beam.

In a light beam scanner having such a light deflection disc, it is preferred that the inclined face be inclined in the radial direction in each of the plurality of light deflection regions, and the angle of inclination of the inclined face be continuously varied in each of the plurality of light deflection regions arranged in the circumferential direction.

Also, in the present invention, the inclined face may be inclined in the circumferential direction in each of the plurality of light deflection regions, and the angle of inclination of the inclined face may be continuously varied in each of the plurality of light deflection regions arranged in the circumferential direction.

In the present invention, it is preferred that the plurality of light deflection regions be radial divisions in the circumferential direction.

In the present invention, when the aforementioned light deflection disc is used as the light deflector, it is preferred that a light incident on the light deflection disc is the light beam that focuses on or in the vicinity of the light deflection disc in the circumferential direction of the light deflection disc. With this configuration, the light deflector can be downsized and a two-dimensional light scan can be carried out.

In the present invention, when the aforementioned light deflection disc is used as the light deflector, it is preferred that the light incident on the light deflection disc be the light beam that focuses on or in the vicinity of the light deflection disc in both the circumferential direction and the radial direction of the light deflection disc. With this configuration, the light deflector can be downsized and a one-dimensional scan can also be carried out in addition to a two-dimensional light scan.

In the present invention, the light deflection mechanism has a light deflection disc as the light deflector and a rotation-drive mechanism for rotating the light deflection disc; when a transmitting light deflection disc having a disc surface on which inclined faces are formed for refracting the incident light beams is used as the light deflection disc, the inclined faces are formed such that the angles of inclination in the radial direction or in the circumferential direction are varied continuously in the circumferential direction.

In the present invention, the light deflection mechanism has a light deflection disc as the light deflector and a rotation-driving mechanism for rotating the light deflection disc; when a reflective light deflection disc having a disc surface on which the inclined faces that reflect the incident light beams is used as the light deflection disc, the inclined faces may be formed such that the angles of inclination in the radial direction or in the circumferential direction are varied continuously in the circumferential direction.

### BRIEF DESCRIPTION OF DRAWING

FIG. 1 An explanatory illustration showing the state of a light beam scanner of Embodiment 1 of the present invention, in which a light emitted from a light source device is irradiated onto a polygonal mirror.

FIG. 2(a) and (b) are respectively an explanatory illustration showing the state of the light beam directed in the first direction, the light beam being emitted from the light source device used in the light beam scanner of Embodiment 1, and an explanatory illustration showing the state of the light beam directed in the second direction.

FIG. 3(a), (b) and (c) are respectively explanatory illustrations showing the directional relationship between the converging direction of the light beam and the polygonal mirror in the light beam scanner of Embodiment 1 of the present invention.

FIG. 4(a), (b), (c) and (d) are respectively a cross-sectional disassembly view of an aperture stop and a light-emitting source used in the light source device, an end view of the aperture stop, an explanatory illustration of an aperture opening and an explanatory illustration of another aperture opening.

FIG. 5 A perspective view of a configuration of a light beam scanner of Embodiment 2 of the present invention.

FIG. 6 A side view of a diagrammatically-illustrated configuration of the light beam scanner shown in FIG. 5.

FIG. 7 A perspective view of the diagrammatically-illustrated configuration of the light beam scanner shown in FIG. 5.

FIG. 8 A top view of a transmitting light deflection disc of the light beam scanner shown in FIG. 5.

FIG. 9(a), (b) and (c) are respectively cross-sectional views of the transmitting light deflection disc of FIG. 8, taken along the X-X line, the Y-Y line and the Z-Z line.

FIG. 10 An explanatory illustration showing the transmitting light deflection disc of FIG. 8, in which the inclined faces include an inclined face having the angle of inclination of 0°.

FIG. 11 A side view of a diagrammatically-illustrated configuration of a light beam scanner of Embodiment 3 of the present invention.

FIG. 12 A perspective view of the diagrammatically-illustrated configuration of the light beam scanner shown in FIG. 11.

FIG. 13 A top view of a transmitting light deflection disc of Embodiment 3 of the present invention.

FIG. 14 A cross-sectional view of the transmitting light deflection disc shown in FIG. 13, taken along the W-W line.

FIG. 15 A side view of a diagrammatically-illustrated configuration of a light beam scanner of Embodiment 4 of the present invention.

FIG. 16 A perspective view of a diagrammatically-illustrated configuration of a transmitting light deflection disc used in a light beam scanner of the Modification Example of Embodiment 2 of the present invention.

FIG. 17 A perspective view of a diagrammatically-illustrated configuration of a transmitting light deflection disc used in a light beam scanner of the Modification Example of Embodiment 3 of the present invention.

### DESCRIPTION OF CODE

| 1a, 1b, 1c | Light beam scanner |
|---|---|
| 10 | Light source device |
| 20 | Light-emitting source |
| 30 | Lens |
| 40 | Aperture stop |
| 200, 300, 400 | Light deflection mechanism |
| 210 | Polygonal mirror (Light deflector) |
| 310 | Transmitting light deflection disc (Light deflector) |
| 410 | Reflective light deflection disc (Light deflector) |

### BEST FORM OF THE INVENTION

A best form for the embodiments of the present invention is described hereinafter based on the drawings.

### EMBODIMENT 1

### (Overall Configuration)

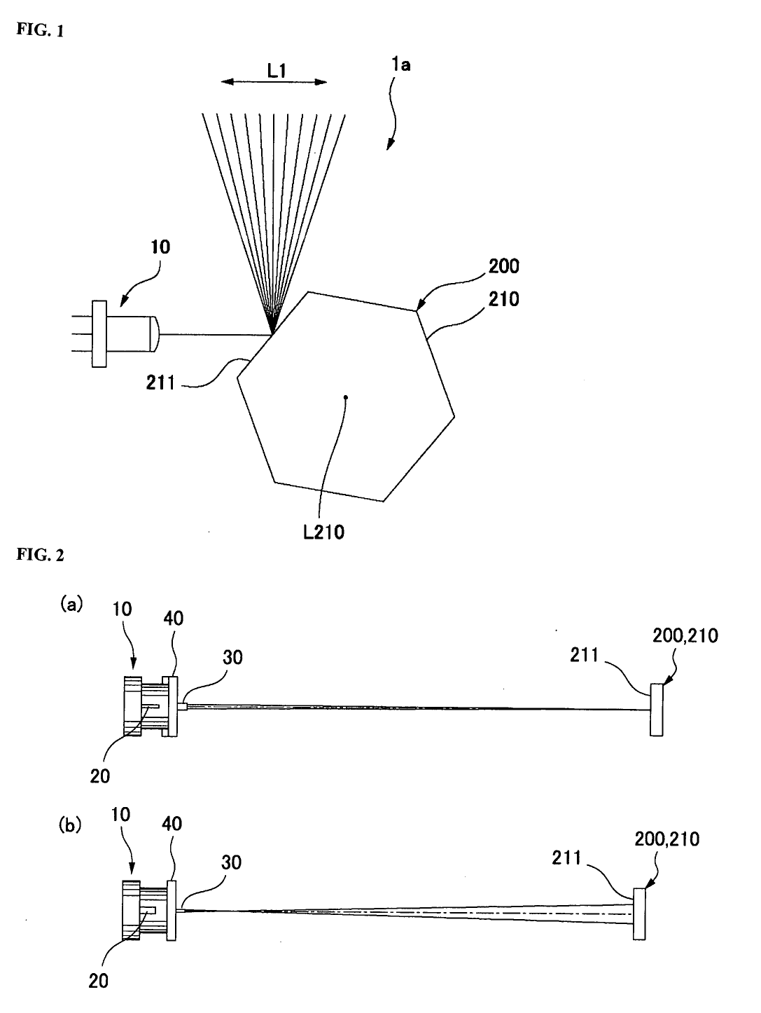

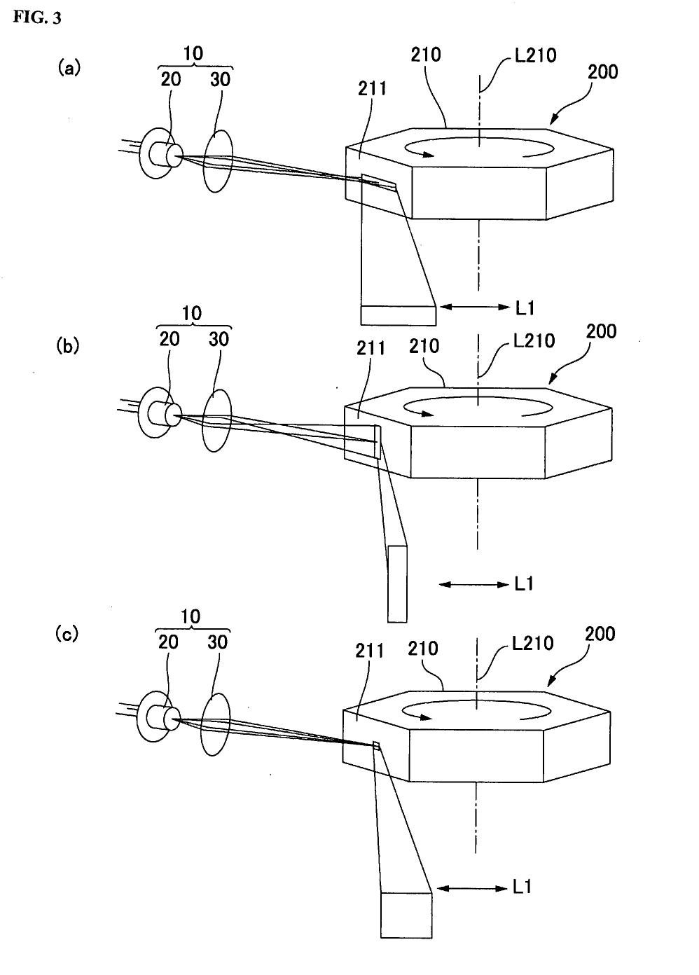

FIG. 1 is an explanatory illustration showing the state of a light beam scanner of Embodiment 1 of the present invention, in which a light emitted from a light source device is irradiated on a polygonal mirror. FIGS. 2 (a) and (b) are respectively an explanatory illustration showing the state of the light beam directed in the first direction, the light beam being emitted from the light source device used in the light beam scanner of Embodiment 1, and an explanatory illustration showing the state of the light beam directed in the second direction. FIG. 3 (a), (b) and (c) are respectively explanatory illustrations showing the directional relationship between the converging direction of the light beam and the polygonal mirror in the light beam scanner of Embodiment 1 of the present invention.

As shown in FIG. 1, a light beam [scanner] 1a has a light source device 10 for emitting a laser light of 880 nm, for example, and a light deflection mechanism 200 by which a light beam emitted from the light source device 10 is scanned with a light deflector over a predetermined range of angles. In this embodiment, the light deflection mechanism 200 has a polygonal mirror 210 as the light deflector and a drive mechanism composed of a motor (not illustrated) for rotating the polygonal mirror 210 about the axis line L210.

Since a known configuration can be adopted for the light deflection mechanism 200 in which the polygonal mirror 210 is used, its description is omitted. As shown in FIG. 2 (a) and (b), the light source device 10 has a light emitting source 20 composed of a laser diode (a laser LED) and a lens 30 for guiding a light beam emitted from the light emitting source 20 as a converging beam that focuses on or in the vicinity of a reflective surface 211 of the polygonal mirror 210 in at least one of the directions, the first direction (for example, in the vertical direction) or the second direction (for example, in the horizontal direction), which are perpendicular to the optical axis direction.

Used as the lens 30 can be an aspherical lens having a positive power, a toric lens, a toroidal lens, or a cylindrical lens. In this embodiment, the lens 30, as shown in FIG. 2 (a), guides a light beam as a converging light that focuses on or in the vicinity of the reflective surface 211 of the polygonal mirror 210 in the first direction perpendicular to the optical axis direction; as shown in FIG. 2 (b), the lens 30 guides a light beam onto the reflective surface 211 of the polygonal mirror 210 in the state of a diverging light in the second direction which is perpendicular to both the optical axis direction and the first direction.

The light source device 10 has an aperture stop 40 as shown in FIG. 2 (a), (b). Therefore, in the light beam scanner 1a of the present invention, a light beam emitted from the light emitting source 20 takes the following values:

In the first direction (vertical direction)

the angle of emission of the light beam as emitted from the light emitting source 20=26°

the angle of emission of the light beam as exiting from the aperture stop=12.9°

the angle of emission of the light beam as exiting from the lens 30=0.52°;

In the second direction (horizontal direction)

the angle of emission of the light beam as emitted from the light emitting source 20=11°

the angle of emission of the light beam as exiting from the aperture stop=5.49°

the angle of emission of the light beam as exiting from the lens 30=2.8°

Therefore, the lens 30 focuses the light beam emitted from the light emitting source 20 in the first direction or the second direction, in whichever the light beam diverges at a larger diverging angle. Note that a configuration can be adopted in which the lens 30 focuses the light beam emitted from the light emitting source 20 in the first direction or the second direction, in whichever the light beam diverges at a smaller diverging angle.

In the light beam scanner la configured as above, as shown in FIG. 3 (a), a light beam emitted from the light source device 10 is irradiated as an oblong spot on the reflective surface 211 of the polygonal mirror 210 and scanned in the direction shown by arrow L1 as the polygonal mirror 20 is driven. In other words, a light beam emitted from the light source device 10 is the light beam that focuses on or in the vicinity of the reflective surface 211 of the polygonal mirror 210 in the direction parallel to the axial line L210 (the center axis line of rotation) of the polygonal mirror 210, and the light beam extending in the scan direction indicated by arrow L1 is scanned in the direction indicated by arrow L1.

With such a configuration, on the reflective surface of the polygonal mirror 210, the incident beam is focused in the first direction; therefore, the top-to-bottom width (vertical width) of a spot formed on the reflective surface 211 is narrow compared to one formed by a conventional device. For this reason, a thin-type polygonal mirror 210 can be used and a one-dimensional light scan can be carried out.

As shown in FIG. 3 (a) and (b), opposite from the configuration shown in FIG. 2 (a), (b), when the lens 30 guides a light beam emitted from the light-emitting source 20 onto the reflective surface 211 of the polygonal mirror 210 in the state of a diverging light in the first direction (vertical direction) which is perpendicular to the optical axis direction and guides a light beam as a converging light that focuses on or in the vicinity of the reflective surface 211 of the polygonal mirror 210 in the second direction (horizontal direction) which is perpendicular to the optical axis direction, the light beam emitted from the light source device 10 is irradiated as a vertical spot onto the reflective surface 211 of the polygonal mirror 210 and scanned as a light beam of a diverging light having a predetermined angle of emerging. In other words, a light beam emitted from the light source device 10 is the light beam that focuses on or in the vicinity of the reflective surface 211 of the polygonal mirror 210 in the direction which is perpendicular to the axis line L210 (center axis line of rotation) of the polygonal mirror 210; the light beam extending in the direction perpendicular to the scan direction indicated by arrow L1 is scanned in the direction indicated by arrow L1.

According to such a configuration, on the reflective surface 211 of the polygonal mirror 210, the incident light beam focuses in the second direction; therefore, the lateral width of a spot formed on the reflective surface is narrow compared to one formed by a conventional device. For this reason, a mirror with a small external dimension can be used as the polygonal mirror 210. Also, a vertical light beam exits from the polygonal mirror 210, and the light beam is scanned in the direction indicated by arrow L1 with the rotation of the polygonal mirror 210. For this reason, when the light beam scanner la is used for observation, a two-dimensional scan can be performed and a watching range in the direction perpendicular to the scan direction indicated by arrow L1 can be wide.

As shown in FIG. 3 (c), when the lens 30 guides a light beam as a converging light that focuses on or in the vicinity of the reflective surface 211 of the polygonal mirror 210 in both the first direction (vertical direction) and the second direction (horizontal direction) which are perpendicular to the optical axis direction, that is, a light incident on the polygonal mirror 210 is the light beam that focuses on or in the vicinity of the reflective mirror 211 of the polygonal mirror 210 in both the vertical direction and the horizontal direction with respect to the axis line L210 (center line of rotation) of the polygonal mirror 210, the light beam is irradiated as a very small spot. Therefore, a mirror which is very thin and small in the external dimension can be used for the polygonal mirror 210. In addition to the two-dimensional light scan, a one-dimensional light scan can be carried out.

Thus, in the light beam scanner 1a of this embodiment, the polygonal mirror 210 can be downsized, and therefore, an inexpensive mirror can be used for the polygonal mirror 210. Also, when the polygonal mirror 210 is downsized, the balance of the polygonal mirror when driven can be improved and then a highly precise light scan can be carried out and the drive mechanism such as a motor for driving the polygonal mirror 210 can be downsized. Thus, the light beam scanner la can be greatly downsized.

### Detailed Description of Light Source Device

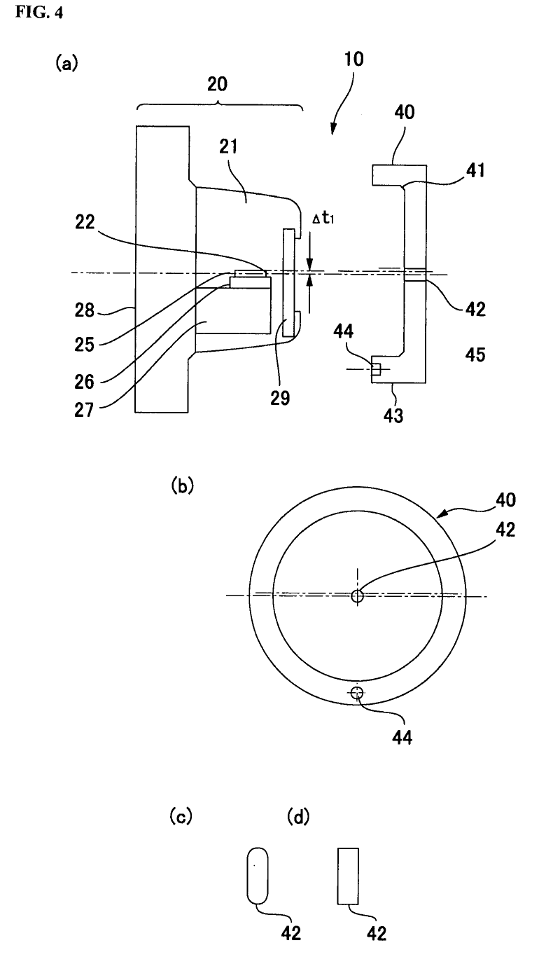

FIG. 4 (a), (b), (c) and (d) are respectively a cross-sectional disassembly view of an aperture stop and a light emitting source used in the light source device, an end view of the aperture stop, an explanatory illustration of the aperture opening, and an explanatory illustration of another aperture opening.

The light source device 10 used in this embodiment has an aperture stop 40 between the light emitting source 20 and lens 30. As shown in FIG. 4 (a) and (b), the aperture stop 40 is a holder-type aperture stop having a recess portion 41 in which the light emitting source 20 can be attached, and an aperture opening 42 is formed in the center of the front end face thereof. The lens 30 shown in FIG. 2 (a) and (b) has the same outer diameter as that of the aperture opening 42 of the aperture stop 40, and is attached to the aperture stop 40 as if put upon the aperture opening 42.

The center position of the aperture opening 42 of the aperture stop 40 is coincided with the center position of the outside diameter of the aperture stop 40. When the light emitting source 20 is a CAN-type semiconductor laser, a cylindrical case 21 of the light-emitting source is attached in the recess portion 41 of the aperture stop 40. When a CAN-type semiconductor laser is used, a laser chip 25 is mounted on a substrate 27 via a sub-mount 26; therefore, the center position of the outside diameter of the cylindrical case 21 is displaced as seen from a light-emitting point 22. In this embodiment, then, the center position of the recess portion 41 is displaced from the center position of the outside diameter of the aperture stop 40 by the dimension At by which the center position of the outside diameter of the cylindrical case portion 21 of the light-emitting source 20 is displaced from the light-emitting point 22. In the light-emitting source 20, the front end opening of the cylindrical case portion 21 is covered by a transparent cover 29, and a wire substrate 28 is attached on the back side of the case portion.

In the end face of the cylindrical portion 43 of the aperture stop 40, a positioning hole 44 is bored to adjust the angle position when the light emitting source 20 is held in the aperture stop 40. Therefore, simply by attaching the cylindrical case portion 21 of the light-emitting source 20 in the recess portion 41 of the aperture stop 40, the center position of the opening 42 of the aperture stop 40 can be coincided with the optical axis originated from the light-emitting point 22 in the light emitting source 20; and with this, the position of the light-emitting point 22 of the light-emitting source 20 (the center position of the aperture opening 42 of the aperture stop 40) is coincided with the center position of the outside diameter of the aperture stop 40.

Thus, in this embodiment, the light source device 10 is simply mounted in the light beam scanner la using the outside diameter of the aperture stop 40 as a reference to obtain a highly precise positioning of the light-emitting point 22 of the light emitting source 20.

In the light source device 10 of this embodiment, the aperture stop 40 and the lens 30 are attached together in the cylindrical case portion 21 in the light emitting source 20; therefore, the entire length of the light source device 10 is measured by the length dimension of the cylindrical case 21+about 2 mm, which is very short.

Also, since the lens 30 is positioned close to the light emitting source 20, the effective diameter of the lens 30 can be small. Therefore, an inexpensive lens can be used for the lens 30. Again, since the lens 30 is positioned close to the light emitting source 20, the focusing length is short. Therefore, the distance between the light source device 10 and the polygonal mirror 200 can be reduced to 100 mm or less, or to about 50 mm in this embodiment, for example. Consequently, the light beam scanner 1A can be downsized.

In this embodiment, the lens 30 has an aspherical surface (curved surface) having a positive power on the light emitting source 20 side, and a plane on the polygonal mirror 210 side. Thus, there is no projection from the lens 30 toward the light-emitting surface of the light source device 10; therefore, when the light source device 10 is installed in the light beam scanner 1a, the light-exiting surface of the lens 30 will not be damaged.

Furthermore, since an aspherical lens is used for the lens 30, the rotation is symmetric unlike a toric lens; therefore, the optical axes can be easily coincided and there is no need to adjust rotations.

In this embodiment, since the light emitting source 20 is pulse driven, heat generation is very small. Therefore, a resin lens can be used for the lens 30; with such a resin lens, even an aspherical lens can be manufactured inexpensively by resin-molding.

In the above embodiment, the aperture opening 42 of the aperture stop 40 is a circular opening; however, it may be an elongated opening as shown in FIG. 4 (c) or may be a rectangular opening as shown in FIG. 4 (d). When an elongated aperture opening 42 shown in FIG. 4 (c) is formed using an end mill, it is preferred that the front end face 45 of the aperture stop 40 in which the opening 42 is formed be thin. Also, a rectangular aperture opening 42 shown in FIG. 4 (d) can be formed by electric spark machining.

Note that the lens 30 can use a toric lens, a toroidal lens, or a cylindrical lens other than an aspherical lens having a positive power. When one of the surfaces of the lens 30 is a flat surface, the lens 30 may be positioned so that the flat surface thereof faces the light-emitting source 20.

### EMBODIMENT 2

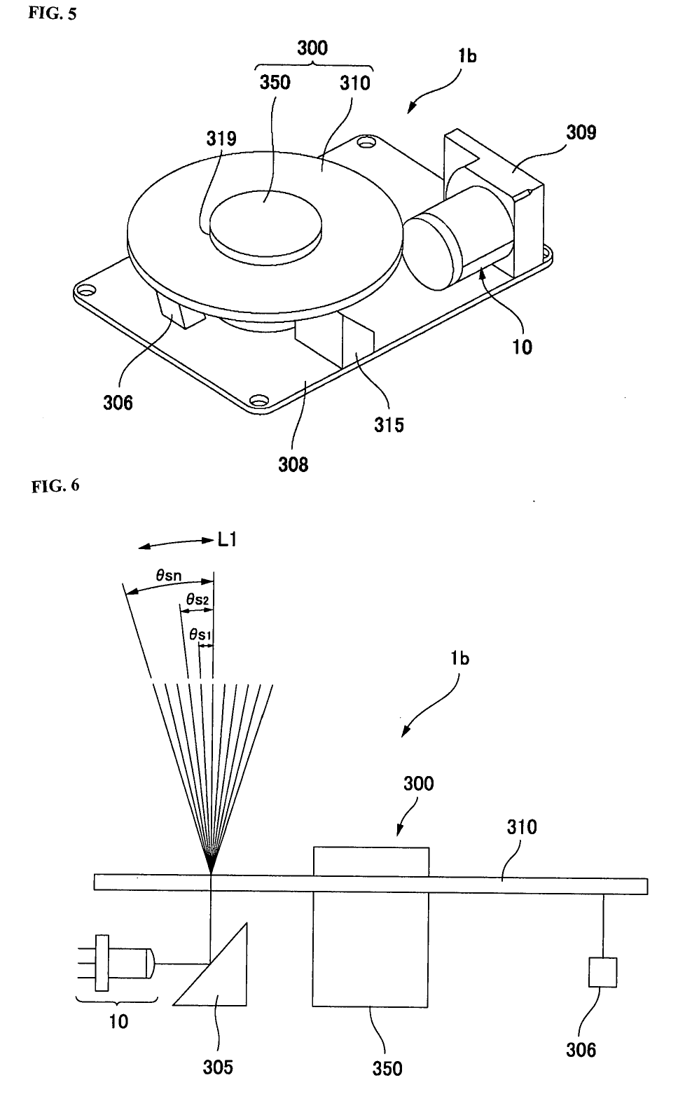

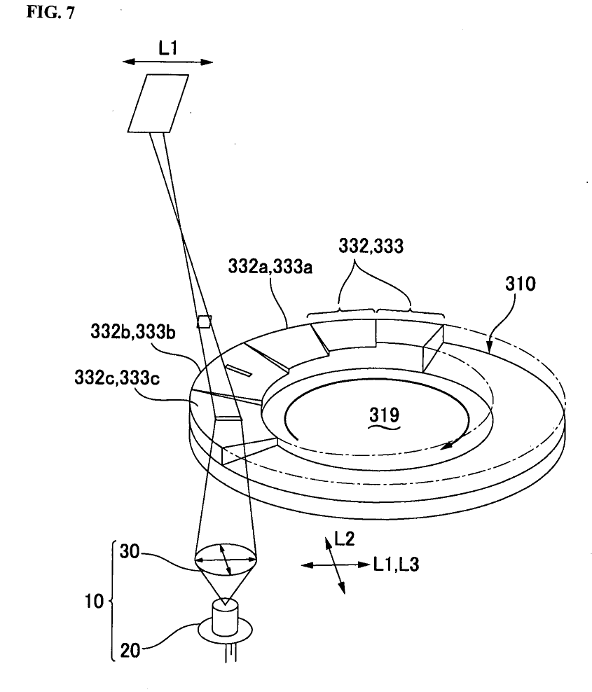

FIG. 5 is a perspective view of a configuration of a light beam scanner of Embodiment 2 of the present invention. FIG. 6 is a side view of the diagrammatically-illustrated configuration of the light beam scanner shown in FIG. 5. FIG. 7 is a perspective view of the diagrammatically-illustrated configuration of the light beam scanner shown in FIG. 5.

A light beam scanner lb shown in FIG. 5, FIG. 6 and FIG. 7 has the light source device 10 described referring to FIG. 2 and FIG. 4 and a light deflection mechanism 300 by which a light beam emitted from the light source device 10 is scanned with a light deflector over a predetermined range of angles. In this embodiment, the light deflection mechanism 300 has a transmitting light deflection disc 310 as the light deflector and a drive mechanism composed of a motor 350 for rotating the transmitting light deflection disc about the axis line. Also, the light beam scanner 1b is equipped with a mirror 305 that raises a light beam emitted from the light source device 10 toward the transmitting light deflection disc 310 and an optical encoder 306 as a position detector that detects the position of rotation of the transmitting light deflection disc 310.

In the light beam scanner 1b of this embodiment, with the transmitting light deflection disc 310 being rotated, a light beam emitted from the light source device 10 enters the transmitting light deflection disc 310 and is refracted at the transmitting light deflection disc 310 so that the light beam is scanned in a predetermined direction. The drive motor 350, the mirror 305 and the optical encoder 306 are directly arranged on frame 308, and the light source device 10 is arranged onto the frame 308 via the holder 309.

In the light beam scanner 1b configured as above, a light beam is emitted from the light source device 10 toward a plane orthogonal to the shaft of the drive motor 350, that is, in the direction parallel to the disc surface of the transmitting light deflection disc 310. The mirror 305 is a mirror that raises the light beam emitted from the light source device 10 in the axial direction of the drive motor 350 in order to have the light beam perpendicularly enter the disc surface of the transmitting light deflection disc 310. The mirror 305 is a total reflection mirror, for example, and is arranged on the light-emitting side of the light source device 10. The drive motor 350 is a blushless motor capable of rotating at high speed, which is configured to be able to rotate at the rate of 10000 (rpm), for example. Note that the drive motor 350 is not limited to a blushless motor, but various kinds of motors such as a stepping motor can be applied. Also, the mirror 305 may be omitted so that a light emitted from the light source device 10 may be directly guided to the transmitting light deflection disc 310.

In this embodiment, the transmitting light deflection disc 310 has a center opening 319 in the center thereof, which is fixed to a rotor of the drive motor 350. Thus, the transmitting light deflection disc 310 is rotated about the shaft of the drive motor 350 (the center of the transmitting light deflection disc 310). The detailed configuration of the transmitting light deflection disc 310 is described later.

The optical encoder 306 is arranged so as to face the transmitting light deflection disc 310 in the axial direction of the drive motor 350. A grating (not illustrated in the figure) is formed on the surface of the transmitting light deflection disc 310 that is opposite to the optical encoder 306; the optical encoder 306 detects the grating to detect the rotational position of the transmitting light deflection disc 310. In the light beam scanner lb of this embodiment, the rotation of the drive motor 350 is controlled based on the detection result of the optical encoder 306. Also, the light-emitting operation of the laser diode which is the light-emitting source of the light source device 10 is controlled based on the detection result of the optical encoder 306. Note that a photo coupler or magnetic sensor may be used in place of the optical encoder 306 for detecting the angle position of the transmitting light deflection disc 310.

### (Configuration of Transmitting Light Deflection Disc)

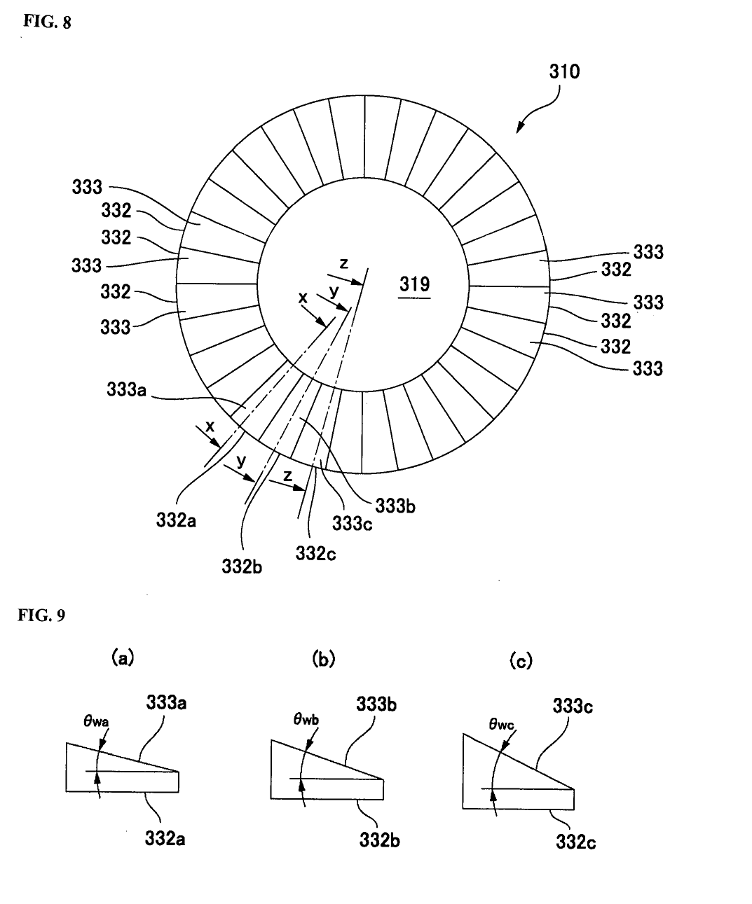

FIG. 8 is a top view of the transmitting light deflection disc used in the light beam scanner shown in FIG. 5. FIG. 9 shows cross-sectional views of the transmitting light deflection disc shown in FIG. 6: (a), (b) and (c) are respectively a cross-sectional view taken along the X-X line, a cross-sectional view taken along the Y-Y line and a cross-sectional view taken along the Z-Z line. FIG. 10 is an explanatory illustration showing that an inclined face having the angle of inclination of 0° is included in the inclined faces of the transmitting light deflection disc shown in FIG. 8.

As shown in FIG. 6, FIG. 7 and FIG. 8, the transmitting light deflection disc 310 is formed in a flat disc shape having a center opening 319 in the center thereof; in this embodiment, it is formed of a transparent resin. The transmitting light deflection disc 310 has thereon a plurality of light deflection regions 332a, 332b, . . . (hereinafter they are denoted as the light deflection regions 332) which are radially created by dividing the disc surface in the circumferential direction around the center opening 319. The light deflection regions 332 are created by dividing the surface in the circumferential direction at equal angular intervals around the center opening 319.

The number of the light deflection regions 332 is determined by the number of scan points of the light beam scanning; in this embodiment, 201 light deflection regions 332 are formed. For example, when the scan range of a light beam is ±10°, the scan resolution of the light beam is 0.1°. Also, when the diameter of the transmitting light deflection disc 310 at the position where the light beam passes through is 40 mm, the circumferential width of a light deflection region 332 at which the light beam passes through is 0.63 mm. Note that in FIG. 7 and FIG. 8, the number of the light deflection regions 332 is reduced in the figure for convenience of description.

In each of the light deflection regions 332, an inclined face 333 that refracts the incident light beam is formed to incline in the radial direction. In this embodiment, the inclined face 333 is formed over the entire circumference only on the light-exiting surface (the top face in FIG. 5, FIG. 6 and FIG. 7) of the transmitting light deflection disc 310 and the light-incident surface (the bottom face in FIG. 5, FIG. 6 and FIG. 7) of the disc is formed as a plane which is orthogonal to the shaft of the drive motor 350.

The inclined face 333 is formed to have a predetermined angle in each of the light deflection regions 332. Further, as shown in FIG. 7 and FIG. 9, the inclined face 333 is inclined in the radial direction in each of the plurality of light deflection regions 332; therefore, the cross section of each light deflection region 332 in the radial direction is in a wedge shape. More specifically, the cross section of each light deflection region 332 in the radial direction shows a trapezoid shape having a pair of parallel lines on the inner circumferential side and outer circumferential side. Also, the angle of inclination of the inclined face 333 is changed continually in each of the plurality of light deflection regions 332 which are arranged along the circumferential direction. Note that the plurality of inclined faces 333 may include one having the angle of inclination of 0° like the inclined face 333e in FIG. 10.

In this embodiment, the inclined face 333 is formed to satisfy the following relationship:

sin (θw+θs)=n·sin θw

where θw is the angle of inclination of the inclined face 333, θs is the scan angle of the light beam exiting from the transmitting light deflection disc 310 (see FIG. 6) and n is index of refraction of the transmitting light deflection disc 310. Here, n is the angle of refraction of a material composing the transmitting light deflection disc 310; giving n=1.51862, for example, when the scan angle, θs, is 100, the angle of inclination, θw, can be given 18.02°.

In this embodiment, the angle of inclination, θw, of an inclined face 333 of the adjacent light deflection region 332 is gradually increased or decreased. For example, as shown in FIG. 9 (a) through (c), the angles of inclination θwa, θwb, θwc of the inclined faces 333a, 333b, 333c of the adjacent light deflection regions 332a, 332b and 332c are increased gradually.

When the transmitting light deflection disc 310 is seen in its entire circumference as shown in FIG. 10, the inclined face 333d of the light deflection region 332d is inclined toward the inner circumference and the inclined face 333f of the light deflection region 332f is inclined toward the outer circumference. Between the light deflection regions 332d and 332f there is a light deflection region 332e having the angle of inclination of 0°. In other words, when the angle of inclination toward the inner circumference and the angle of inclination toward the outer circumference are respectively determined as a positive angle of inclination and a negative angle of inclination, the angle of inclination θw of the inclined face 333 is gradually changed from positive to negative in the circumferential direction, and as the angle of inclination is further reduced and it goes around, it returns to a positive angle of inclination. Note that the inclined face 333 may be formed so the positive angle of inclination and the negative angle of inclination are alternated in the circumferential direction so that the inclined face is gradually changed from a positive angle of inclination to a negative angle of inclination and then from negative to positive. Also, an anti-reflection coating as a thin film or a fine structure configured with fine pyramid-shaped protrusions may be applied on the transmitting light deflection disc 310.

### (Method for Manufacturing the Transmitting Light Deflection Disc)

The transmitting light deflection disc 310 may be manufactured of a transparent resin directly by an ultra precision machining such as cutting, or by a metallic mold to lower a manufacturing cost. Although hereinafter is described a method for manufacturing the transmitting light deflection disc 310 directly by cutting, a method using a metallic mold is the same.

The transmitting light deflection disc 310 is cut using a fly cut or a shaper cut. In this embodiment, an inclined face 333 is formed to incline in the radial direction; therefore, the direction in which a blade used for cutting is moved is set in the radial direction of the transmitting light deflection disc 310. More specifically described, the blade is set to move from the center toward the outer circumference of the transmitting light deflection disc 310 or from the outer circumference toward the center.

While the material of the transmitting light deflection disc 310 is moved in the axial direction, a cutting process is carried out to form an inclined face 333 of a light deflection region 332. Then, the transmitting light deflection disc 310 is rotated at a predetermined angle in the circumferential direction, and while the material of the transmitting light deflection disc 310 is moved in the axial direction, another cutting process is carried out in the same manner as above to form an inclined face 333 of the adjacent light deflection region 332. This operation is repeated around the disc to form a transmitting light deflection disc 310. Note that the axial moving of the material of the transmitting light deflection disc 310 is determined by NC data, by which an inclined face 333 is formed such that the angle of inclination, θw, of the inclined face 333 of the adjacent light deflection region 332 gradually increases or decreases.

### (Method of Light Beam Scan)

A method of light beam scan by the light beam scanner 1b having the above configuration is described hereinafter.

First, the transmitting light deflection disc 310 is rotated by the drive motor 350 at a predetermined rate of rotation. In this state, a laser light is emitted from the light source device 10 and raised by the mirror 305 to perpendicularly enter the light-incident surface of the transmitting light deflection disc 310. More specifically described, the light beam enters the center position in the circumferential width of a light deflection region 332.

Here, it is preferred that the effective diameter of the light beam incident on the transmitting light deflection disc 310 be equal to or less than the circumferential width of a light deflection region 332. For convenience of description, the effective diameter of the light beam incident on the transmitting light deflection disc 310 is equal to or less than the circumferential width of a light deflection region 332.

A light beam incident on the light deflection region 332 of the transmitting light deflection disc 310 is refracted at the inclined face 333 when transmitted through the transmitting light deflection disc 310, and then exits the disc. For example, as shown in FIG. 6, the light beam is refracted in a certain light deflection region 332 in the direction of the scan angle θs1 and then exits the disc. Here, the angle of inclination, θw, of the inclined face 333 of the adjacent light deflection region 332 is gradually increased or decreased as described above; therefore, in the adjacent light deflection region 332, a light beam is refracted in the direction of the scan angle θs2 which is 0.1° different from the scan angle θs1, and then exits the disc. Therefore, the light beams exit in sequence at 0.1° intervals so that a predetermined scanning range is scanned. At that time, at the light deflection region 332e shown in FIG. 10, the light beam exits the disc without being refracted.

When such a light beam scan is carried out, the rotation of the drive motor 350 and the light-emitting operation of the light-emitting source of the light source device 10 are controlled based on the rotational position of the transmitting light deflection disc 310 as detected by the optical encoder 306. In other words,. based on the detection result by the optical encoder 306, the rotation of the drive motor 350 and the light-emitting timing of the light emitting source are adjusted so that a laser light emitted from the light source device 10 is incident on the center position of a light deflection region 332 in the circumferential direction.

### (Main Effects of This Embodiment)

As described above, in the light beam scanner 1b of this embodiment, while the drive motor 350 is being rotated, a laser light emitted from the light source device 10 is caused to enter the transmitting light deflection disc 310 at which the light beam is refracted to be scanned in a predetermined direction. In other words, a light beam is scanned with a refraction function. For this reason, when multiple inclined faces 333 having mutually different refraction angles are formed in the circumferential direction and the transmitting light deflection disc 310 is rotated to go around, a predetermined scanning range can be scanned. In this case, an inclined face having only a certain refraction angle, θw, may be formed on the transmitting light deflection disc 310 in order to guide the light beam at a certain scan angle; thus, there is no need to provide a plurality of grating grooves in order to guide the light beam at a certain scan angle as in a deflection disc with a diffraction function. Therefore, even when the scan resolution of a light beam is increased, the diameter of the transmitting light deflection 310 can be smaller. As a result, the device can be downsized. Further, since the transmitting light deflection disc 310 is of a flat disc shape, the device can be made thinner as well. Note that since, in the above mentioned example, the circumferential width of the light deflection region 332 at the position at which the light beam is transmitted through is 0.63 mm, the inclined face 333 can be sufficient in size.

Even in this embodiment, in the light source device 10, the lens 30 guides a light beam emitted from the light-emitting source 20 as a converging light that focuses on or in the vicinity of the top face of the transmitting light deflection disc 310 in at least one of the two directions which are perpendicular to the optical axis direction in the same manner as in Embodiment 1.

Therefore, a light beam emitted from the light source device 10 is irradiated on the light deflection region 332 of the transmitting light deflection disc 310 as a spot elongated in the radial direction (the direction indicated by arrow L3), but the width of the spot is narrower in the circumferential direction (the direction indicated by arrow L2) of the transmitting light deflection disc 310. Thus, even in a small-sized transmitting light deflection disc 310, many light deflection regions 332 can be formed.

In the light source device 10, when the lens 30 guides a light beam as a converging light that focuses on or in the vicinity of the top face of the transmitting light deflection disc 310 in both the first direction (vertical direction) and the second direction (horizontal direction) which are perpendicular to the optical axis direction, the light beam is irradiated as a very small spot. Therefore, the transmitting light deflection disc 310 can be downsized and a one-dimensional light scan can be carried out as well.

Note that a configuration may be used in which a light beam emitted from the light source device 10 is irradiated onto a light deflection region 332 of the transmitting light deflection disc 310 as a spot elongated in the direction perpendicular to the radial direction. In this case, the effective diameter of a light beam incident on the transmitting light deflection disc 310 is equal to or more than the circumferential width of a light deflection region 332, and therefore, the light beam may enter the disc as a spot extending over a plurality of light deflection regions 332. Even in such a case, the light beam incident on the light deflection region 332 next to the light deflection region 332 in which the light beam was supposed to enter is guided in the direction away from the light beam that has passed through the light deflection region 332 in which the light beam was supposed to pass through. Consequently, noise will not be generated.

In either case, the transmitting light deflection disc 310 can be downsized, and the balance of the disc when driven can be improved; therefore, a highly precise light scan can be performed; also, the motor 350 that drives the transmitting light deflection disc 310 can be downsized. Accordingly the light beam scanner 1b can be downsized greatly.

Since the light-emitting source 20 emits a light beam having diverging angles that are different in two mutually perpendicular directions and the light beams exiting from the lens 30 has focal points that are different in the two mutually perpendicular directions, the light beam is focused as a vertical spot near the light source device 10 in the light-emitting direction and as an oblong spot far from the light source device 10 in the light-emitting direction, as shown in FIG. 7. As shown in FIG. 7, when the device is configured such that a vertical spot is formed on a disc surface of the transmitting light deflection disc 310 with a light beam emitted from the light source device 10, having the direction in which the narrower width extends coincided with the circumferential direction (the direction indicated by arrow L2) of the transmitting light deflection disc 310, an oblong light beam having a large diverging angle in the circumferential direction exits from the transmitting light deflection disc 310. This light beam is scanned in the radial direction (the direction indicated by arrow L3) with the rotation of the transmitting light deflection disc 310. Consequently when the light beam scanner 1 is used for observation, a two-dimensional light scan can be performed and a wide watching range can be obtained in the direction perpendicular to the scan direction indicated by arrow L1.

For the transmitting light deflection disc 310 used in this embodiment, a refraction effect is utilized and the angle of refraction is hardly affected by the wavelength of the incident light beam. For this reason, in the light beam scanner 1b of this embodiment that uses the transmitting light deflection disc 310, a light beam of a stable intensity can be scanned. Further, even when temperature changes, the change in transmittivity of the transmitting light deflection disc 310 caused by the temperature change is very small compared to the change in diffraction efficiency. Therefore, without being significantly affected by the temperature change, a light beam of a stable intensity can be scanned.

In this embodiment, the device is configured such that a light beam emitted from the light source device 10 passes through the transmitting light deflection disc 310. Therefore, even when a revolution being off-center or an axial runout occurs to the transmitting light deflection disc 310 which is rotated by the drive motor 350, the angle of refraction is hardly changed. Consequently, a jitter can be reduced during the light beam scan.

In this embodiment, the transmitting light deflection disc 310 is configured with a plurality of radial light deflection regions 332 which are divisions in the circumferential direction; in each of the light deflection regions 332 is formed an inclined face 333 for refracting the incident light beam. Thus, the transmitting light deflection disc 310 can be formed with a simple configuration.

Also, in each of the light deflection regions 332 is formed an inclined face 333 having a predetermined angle, and the angle of inclination θw of an inclined face 333 of the adjacent light deflection region 332 is gradually increased or decreased. With such a simple configuration of the device, light beams emerge at successive scan angles θs. Further, the light deflection regions 332 are created by dividing the disc at equal angle intervals in the circumferential direction around the center opening 319. Therefore, if the rate of rotations of the drive motor 350 is constant, only pulsed light beams need to be emitted at constant intervals from the light source device 10, facilitating the control of the light-emitting source.

In this embodiment, the inclined faces 333 are formed only on the light-exiting surface of the transmitting light deflection disc 310 and the light-incident surface is formed as a plane. Therefore, when a metallic mold is used to manufacture the transmitting light deflection disc 310, only one face of a molding piece of die is required, thus facilitating the manufacturing of the metal mold. Also when the transmitting light deflection disk 310 is manufactured by directly cutting a transparent resin, the material can be easily secured and a machining is easy because the light-incident surface is a plane.

In this embodiment, an anti-reflection coating is applied on the transmitting light deflecting disc 310. With this, the light returning to the light-emitting source, which may cause uneven outputs of the light source device 10, can be reduced. In addition, since the transmittivity is increased, the loss of light intensity of the beam emitted from the light source device 10 can be reduced. Note that as long as the light intensity required for a host device in which the light beam scanner 1b is applied is obtained, there is no need to apply an anti-reflection coating on the transmitting light deflection disc 310. In this case, the configuration of the transmitting light deflection disc 310 can be simplified and its manufacturing can be facilitated.

In this embodiment, the transmitting light deflection disc 310 is manufactured of resin. Therefore, the transmitting light deflection disc 310 is excellent in productivity and the light beam scanner 1b can be made lightweigtht at low cost. Note that, even when the temperature changes by ±50°, a fluctuation of the scan angle θs is only 1% or less; thus, a scan performance is hardly affected.

In this embodiment, the rotation of the drive motor 350 and the light-emitting timing of the light-emitting source are so controlled that a light beam emitted from the light source device 10 enters the center position of the circumferential width of the light deflection region 332. Therefore, a precise synchronization can be obtained between the light-emitting timing of the light-emitting source and the rotational position of the transmitting light deflection disc 310 so that an accurate light beam scan can be carried out.

### EMBODIMENT 3

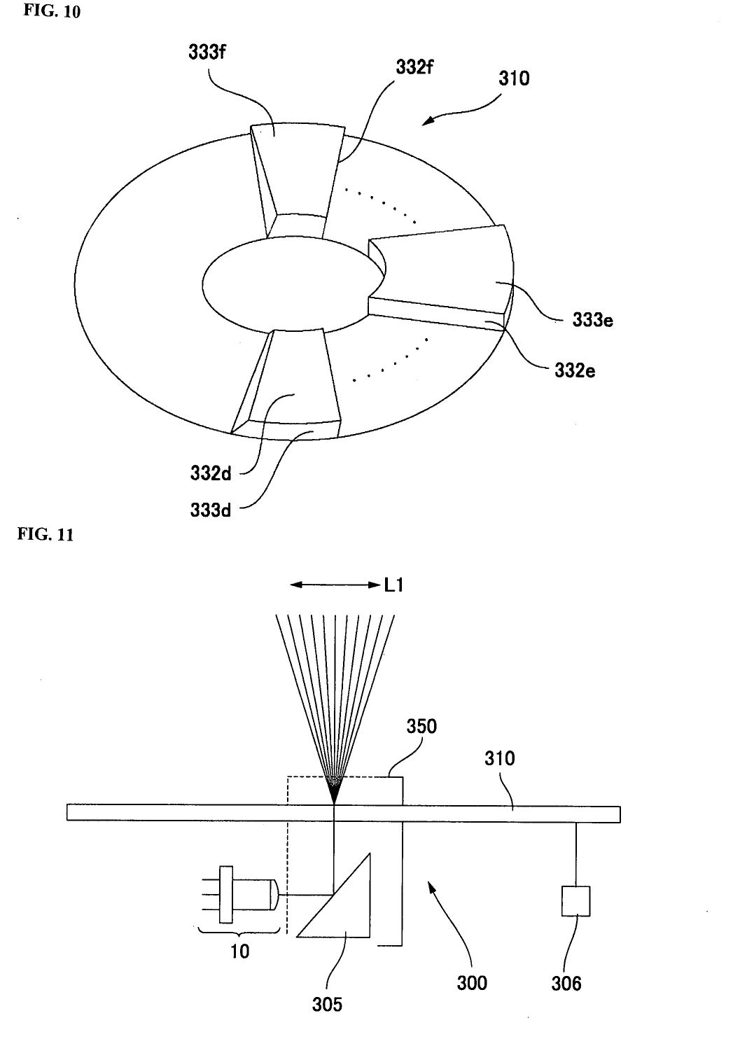

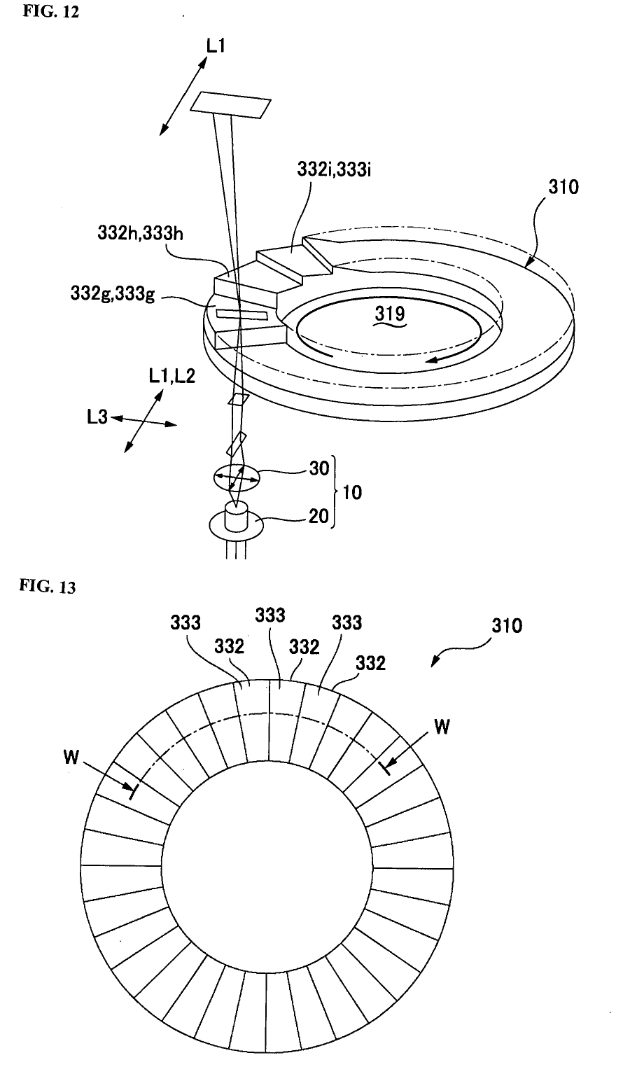

Although the incident laser light is scanned in the radial direction in the above-mentioned Embodiment 2, the device may be configured as follows when a light beam is scanned in the direction of a line tangential to the transmitting light deflection disk 310, as shown in FIG. 11 and FIG. 12. The configuration of this embodiment is described hereinafter, but its basic configuration remains the same as that of Embodiment 2; therefore, the same codes are given to the common portions and their description is omitted.

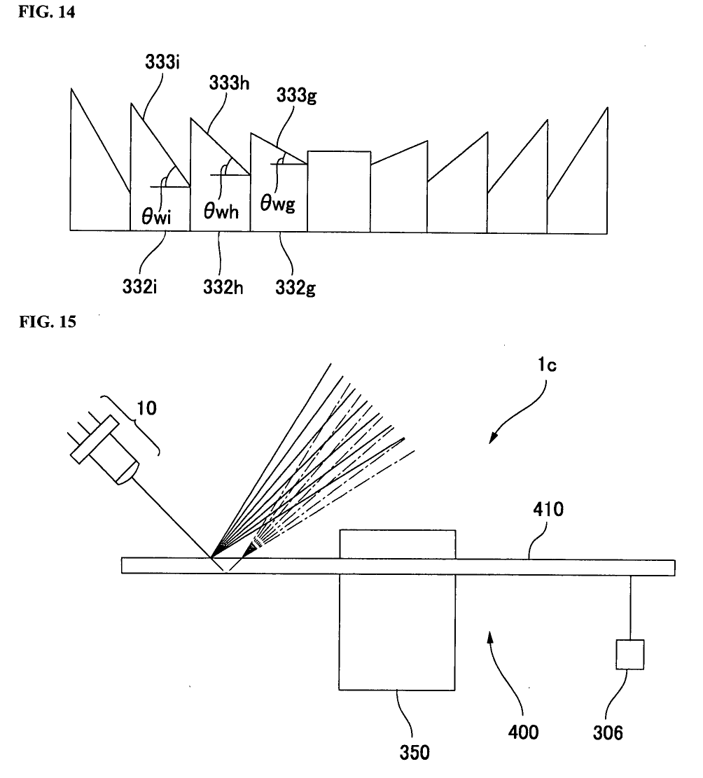

FIG. 11 is a configuration diagram of a light beam scanner of Embodiment 3 of the present invention. FIG. 12 is a perspective view of the diagrammatically-illustrated configuration of the light beam scanner of FIG. 11. FIG. 13 is a top view of a transmitting light deflection disc used in the light beam scanner of Embodiment 3 of the present invention. FIG. 14 is a cross-sectional view of the transmitting light deflection disc of FIG. 13, taken along the W-W line.

In the transmitting light deflection disc 310 used in a light deflection mechanism 300 shown in FIG. 11 and FIG. 12, an inclined face 333 that inclines at a predetermined angle in the circumferential direction is formed in each of the light deflection regions 332 that compose the transmitting light deflection disk 310, as shown in FIG. 13 and FIG. 14. Even in this embodiment, the inclined faces 333 are formed only on the light-exiting surface of the transmitting light deflection disc 310. The inclined face 333 is inclined in the circumferential direction in each of a plurality of light deflection regions 332 and the cross-section of each light deflection region 332 is in a wedge shape. Therefore, each light deflection region 332 is formed such that its cross-section is a trapezoid shape having a pair of parallel sides on the interfaces with the adjacent light deflection regions 332. The angle of inclination of the inclined face 333 is continuously varied in each of the plurality of light deflection regions 332 arranged in the circumferential direction. Even in this embodiment, an inclined face having the angle of inclination of 0° may be included.

The inclined face 333 is formed to satisfy the following relationship:

sin (θw+θs)=n·sin θw

where θw is the angle of inclination of the inclined face 333, θs is the scan angle of the light beam exiting from the transmitting light deflection disc 310 and n is index of refraction of the transmitting light deflection disc 310; also, the angles of inclination θwg, θwh, θwi of the inclined faces 333g, 333h, 333i in the adjacent light deflection regions 332g, 332h and 332i are gradually increased as shown in FIG. 14. These are the same as the above-described Embodiment 2. Note that the inclined faces 333 that incline in the opposite direction from the inclination direction shown in FIG. 14 may be included in the plurality of inclined faces 333. For example, in FIG. 14, the inclined faces 333 on the left side of the center may be inclined down to left and the inclined faces 333 on the right side of the center may be inclined down to right.

The transmitting light deflection disc 310 having the inclined faces 333 that incline in the circumferential direction may be directly manufactured of a transparent resin by a super precision machining such as cutting, or may be manufactured using a metal mold to lower manufacturing cost in the same manner as the above-described embodiment. When the transmitting light deflection disc 310 or a metal mold is fabricated by cutting, a blade used for cutting may be directed in the radial direction of the transmitting light deflection disc 310 to form an inclined face 333, and then while changing the direction of inclination of the blade, the transmitting light deflection disc 310 is rotated at a predetermined angle in the circumferential direction to form an inclined face 333 for the adjacent light deflection region 332.

Even in this embodiment, the light source device 10 is configured such that the lens 30 can guide a light beam emitted from the light-emitting source 20 as a converging light that focuses on or in the vicinity of the top face of the transmitting light deflection disc 310 in at least one of the two directions, the first direction (vertical direction) or the second direction (horizontal direction), which are perpendicular to the optical axis direction, in the same manner as in Embodiment 1.

For example, a light beam emitted from the light source 10 may be irradiated on a light deflection region 332 of the transmitting light deflection disc 310 as a spot elongated in the radial direction (indicated by arrow L3) as shown in FIG. 12, and scanned in the radial direction. Therefore, even with a small transmitting light deflection disc 310, many light deflection regions 332 can be formed.

In the light source device 10, when the lens 30 guides a light beam as a converging light that focuses on or in the vicinity of the top face of the transmitting light deflection disc 310 in both the first direction (vertical direction) and the second direction (horizontal direction) which are perpendicular to the optical axis direction, a light beam is irradiated as a very small spot. Therefore, the transmitting light deflection disc 310 can be downsized and a one-dimensional light scan can be carried out.

Also, a light beam emitted from the light source device 10 may be irradiated onto a light deflection region 332 of the transmitting light deflection disc 310 as a spot elongated in the circumferential direction (indicated by arrow L2) and scanned as a diverging light beam having predetermined angles of emission.

In either case, the transmitting light deflection disc 310 can be downsized, and therefore, the balance of the disc when driven can be improved; as a result, a highly precise light scan can be carried out and the motor for driving the transmitting light deflection disc 310 can be downsized. Accordingly the light beam device 1b can be downsized greatly.

Since the light-emitting source 20 emits a light beam having different diverging angles in the two mutually perpendicular directions, and the light beams exiting from the lens 30 have different focal points in the two mutually perpendicular directions, [the light beam is focused] as a vertical spot near the light source 10 in the light-exiting direction and as an oblong spot far from the device 10 in the light-exiting direction, as shown in FIG. 12. Therefore, as shown in FIG. 12, when the device is configured such that an oblong spot is formed on the disk face of the transmitting light deflection disc 310 with a light beam emitted from the light source device 10 and the direction in which the narrower width [of the spot] extends is coincided with the circumferential direction (indicated by arrow L3) of the transmitting light deflection disc 310, the oblong light beam having a large diverging angle in the radial direction (indicated by arrow L2) exits from the transmitting light deflection disc 310, and scanned in the circumferential direction with the rotation of the transmitting light deflection disc 310. For this reason, when the light beam device 1 is used for observation, a two-dimensional light scan can be carried out and a wide watching range can be obtained in the direction perpendicular to the scan direction indicated by arrow L1.

### EMBODIMENT 4

In the above-described Embodiments 2 and 3, the device is configured such that a light beam emitted from the light-emitting source 20 passes through the transmitting light deflection disc 310; however, it may be configured as in a light beam scanner 1c shown in FIG. 15 such that a light beam emitted from the light source device 10 is reflected on a reflective light deflection disc 410 of a light deflection mechanism 400. For this, the top face of the light deflection disc 310 described referring to FIG. 8 and FIG. 9 or the top face of the light deflection disc 310 described referring to FIG. 13 and FIG. 14 can be formed as a reflective surface to make a reflective light deflection disc 410. Also, as FIG. 15 shows the light-moving direction indicated by a single dotted line, light beams emitted from the light source 10 may be reflected at the bottom face of the reflective light deflection disc 410 of the light deflection mechanism 400. In this case, reflective inclined faces may be formed on the bottom face of the deflection disc 310. As FIG. 15 shows the light-moving direction indicated by a single dotted line, light beams emitted from the light source device 10 may be refracted at the top face of the reflective light deflection disc 410 of the light deflection mechanism 400 and reflected at the bottom face. In this case, the bottom face of the light deflection disc 310 described referring to FIG. 8 and FIG. 9 or the bottom face of the light deflection disc 310 described referring to FIG. 13 and FIG. 14 may be formed as a reflective surface to make a reflective light deflection disc 410.

Even with such configurations, in the light source device 10, the lens 30 can guide a light beam emitted from the light-emitting source 20 as a converging light that focuses on or in the vicinity of the top face of the reflective light deflection disc 410 in at least one of two directions, the first direction (vertical direction) or the second direction (horizontal direction), which are perpendicular to the optical axis direction, in the same manner as Embodiment 1. Therefore, a light beam emitted from the light source device 10 is irradiated onto a light deflection region of the reflective light deflection disc 410 as a spot elongated in the radial direction and scanned as a diverging light beam having a predetermined angle of emission. For this reason, even in a small reflective light deflection disc 410, many light deflection regions can be formed. In the light source device 10, when a light beam is guided as a converging light that focuses on or in the vicinity of the top face of the reflective light deflection disc 410 in both the first direction (vertical direction) and the second direction (horizontal direction) which are perpendicular to the optical axis direction, the light beam is irradiated as a very small spot compared to one by a conventional device. Therefore, the reflective light deflection disc 410 can be downsized. In both cases, the reflective light deflection disc 410 can be downsized and the balance of the disc when driven can be improved, allowing a highly precise light scan to be performed and the drive motor 350 for driving the reflective light deflection disc 410 to be downsized. Consequently the light beam device 1c can be greatly downsized.

### OTHER EMBODIMENTS

The above-described embodiments are suitable examples of the present invention; however, the invention is hot limited to these. For example, the embodiment can be varyingly modified within the scope of the invention as described hereinafter.

The inclined faces 333 are formed only on the light-exiting surface of the transmitting light deflection disc 310 in Embodiments 2 and 3; however, they may be formed only on the light-incident surface or they may be formed on both the light-exiting surface and the light-incident surface. In order to form the inclined faces on both surfaces of the disc, the angles of inclination on the light-incident surface may be the same in all the light deflection regions 332, for example.

The transmitting light deflection disc 310 is formed of resin in Embodiments 2 and 3; however, it may be formed of glass. In this case, the disc is hardly affected by temperature changes, so the temperature property is stable, making it possible to use the light beam scanner in a high temperature environment.

The inclined faces 333 in Embodiment 2 or 3 do not need to be formed over the entire circumference on the light-exiting surface of the transmitting light deflection disk 310, but a flat plane portion may be formed in a portion of the light-exiting surface of the disc.

In place of the optical encoder 306 used in Embodiment 2 or 3, a Hall device or MR device can be used inside the drive motor 350 as a position detector. In this case, pulses are formed with a drive magnet or pulse-generating magnet arranged in the drive motor 350, or with back electromotive force; the light-emitting timing of the light-emitting source can be controlled based on the pulses so that a light beam emitted from the light source device 10 is incident on the center position of a light deflection region 332 in the circumferential direction.

The light beam scanner of Embodiment 2 or 3 does not need to be equipped with a position detecting means. When the transmitting light deflection disc 310 is configured with a plurality of light deflection regions 332 created by dividing the disc surface at equal angle intervals in the circumferential direction as in the above-described embodiments, the drive motor 350 is controlled to rotate at a constant speed; if a pulsed light beam is emitted at constant intervals from the light source device 10, an accurate light beam scan can be performed.

Without providing the mirror 305 of Embodiment 2 or 3, the device may be configured such that light beams may be emitted from the light source device 10 toward the disc surface of the transmitting light deflection disc 310 and may directly enter the transmitting light deflection disc 310. When the mirror 305 is provided, the light source device 10 is arranged diagonally under the transmitting light deflection disc 310 so that a light beam enters the transmitting light deflection disc 310 diagonally from the bottom of the deflection disc 310.

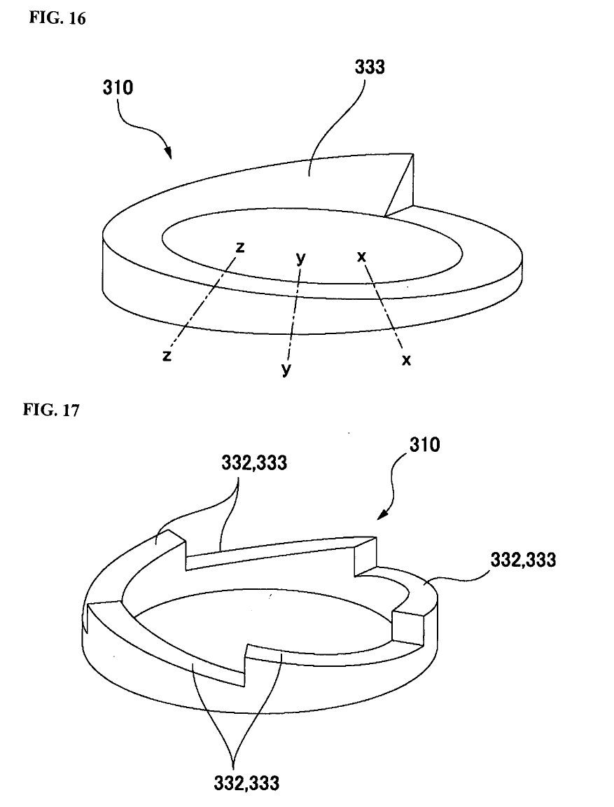

The transmitting light deflection disc 310 used in Embodiment 2 or 3 may have an inclined face having an angle of inclination that continually varies in the circumferential direction, as described hereinafter referring to FIG. 16 and FIG. 17.

FIG. 16 is a perspective view of a diagrammatically-illustrated configuration of a transmitting light deflection disc used in a light beam scanner of the Modification Example of Embodiment 2 of the present invention. Note that the basic configuration of the light beam scanner and transmitting light deflection disc of this embodiment is the same as Embodiment 2; therefore, the same codes are given to the common portions and their description is omitted.

In the transmitting light deflection disc 310 of Embodiment 2, a disc surface is divided into a plurality of light deflection regions 332 in the circumferential direction and an inclined face 333 is formed in each of the light deflection regions 332; however, as shown in FIG. 16, an inclined face 333 which is continuous in the circumferential direction is formed on the disc surface of the transmitting light deflection disc 310 [of this embodiment], and in this inclined face 333 the angle of inclination with respect to the radial direction is continuously varied in the circumferential direction.

The transmitting light deflection disc 310 configured as above has cross sections shown in FIG. 9 (a), (b) and (c) which are taken along the x-x line, the y-y line and the z-z line in FIG. 16, in the same manner as the example described referring to FIG. 8; the angle of inclination θw in the radial direction is gradually increased or decreased in the circumferential direction. Therefore, when a light beam enters the transmitting light deflection disc 310 while having the transmitting light deflection disc 310 is being rotated, the light beam is refracted and scanned as it is transmitted through the transmitting light deflection disc 310. With this configuration, a laser can be continuously oscillated to increase resolution to the maximum. Although the inclined face 333 continuously varies the angle of inclination even in the circumferential direction, the diameter of the incident beam is small; therefore, the change in the inclination in the circumferential direction can be ignored. Thus, the scan in the tangential direction of the transmitting light deflection disc 310 can be ignored.

FIG. 17 is a perspective view of a diagrammatically-illustrated configuration of a transmitting light deflection disc used in a light beam scanner of the Modification Example of Embodiment 3 of the present invention. Note that the basic configuration of the light beam scanner and transmitting light deflection disc of this embodiment is the same as Embodiment 3; therefore, the same codes are given to the common portions and their descriptions are omitted.

In the transmitting light deflection disc 310 of Embodiment 3, a plurality of light deflection regions 332 are formed in the circumferential direction and an inclined face 333 having a constant angle of inclination, θw, is formed in each of the light deflection regions 332. However, in this embodiment as shown in FIG. 17, a plurality of light deflection regions 332 are formed in the circumferential direction, and in each of the light deflection regions 332 an inclined face 333 is formed having the angle of inclination θw in the circumferential direction that is continuously varied in the circumferential direction. The shape of this face is expressed by the second-order function in the tangential direction, and the inclination expressed by the first-order differential calculus continuously changes with respect to the tangential direction. Even in this light beam scanner in which the transmitting light deflection disc 310 having such a configuration is used, a light beam incident on the transmitting light deflection disc 310 is refracted on the inclined face 333 as transmitted through the disc 310 and scanned in the tangential direction of the transmitting light deflection disc 310. Although FIG. 17 shows an example in which the inclined face 333 is inclined only to one side, the inclined face may be in a parabolic U-shape or in a sine curve.

A reflective layer may be formed on the inclined face of the transmitting light deflection disc 310 shown in FIG. 16 and FIG. 17 to produce a reflective light deflection disc having an inclined face which reflects the incident light beam and sends the beam out, on the disk surface. Since the operation of such a reflective light deflection disk is the same as Embodiment 4, its description is omitted.

### INDUSTRIAL ADOPTION POSSIBILITY

In a light beam scanner of the present invention, the light source device emits a converging light that focuses on or in the vicinity of the light deflector in at least one of the two directions, the first direction or the second direction, which are perpendicular to the optical axis direction. With this, the light deflector can be downsized in at least one of the directions, the first direction or the second direction. Thus, such a light deflector can be provided so that its productivity is increased and the number of scan points is increased using a state-of-the-art refining process. With a downsized light deflector, the balance [of the disc] when driven can be improved, so a highly precise light scan can be carried out and the drive mechanism such as a motor to drive the light deflector can be downsized.

1. An optical beam scanner comprising:
a light source device; and
a light deflection mechanism by which a light beam emitted by said light source device is scanned with a light defection device over a predetermined range of angles;
wherein said light source device emits a converging light beam that focuses on or in the vicinity of said light deflector in at least one of the directions, the first direction or the second direction, which are perpendicular to the optical axis direction.

2. The optical beam scanner as set forth in claim 2,
wherein said light source device is equipped with a light-emitting source and a lens for guiding a light beam emitted by said light emitting source as a converging light beam that focuses on or in the vicinity of said light deflector in at least one of the directions, the first direction or the second direction, which are perpendicular to the optical axis direction.

3. The optical beam scanner as set forth in claim 3,
wherein said light-emitting source is a laser LED.

4. The optical beam scanner as set forth in claim 2,
wherein a light beam having different diverging angles in said first direction and in said second direction is incident on said lens; and
wherein said lens focuses the light beam emitted from said light emitting source on or in the vicinity of said light deflector in at least said first or second direction, in whichever the light beam diverges at a larger diverging angle.

5. The optical beam scanner as set forth in claim 2,
wherein a light beam having different diverging angles in said first direction and said second direction is incident on said lens; and
wherein said lens focuses the light beam emitted from said light emitting source on or in the vicinity of said light deflector in at least said first direction or said second direction, in whichever the light beam diverges at a smaller diverging angle.

6. The optical beam scanner as set forth in claim 2,
wherein said lens guides a light beam emitted from said light emitting source as a converging light that focuses on or in the vicinity of said light deflector in both said first direction and said second direction.

7. The optical beam scanner as set forth in claim 2,
wherein the distance between said light-emitting source and a focusing position of said converging light is 100 mm or less.

8. The optical beam scanner as set forth in claim 2,
wherein said lens is either an aspherical lens having a positive power, a toric lens, a toroidal lens or a cylindrical lens.

9. The optical beam scanner as set forth in claim 2,
wherein said lens has a curved surface having a positive power on the said light-emitting source side and also has a plane on the said light deflector side.

10. The optical beam scanner as set forth in claim 2,
wherein said light source device is equipped with a holder-type aperture stop having a recess portion between said light emitting source and said lens, in which said light-emitting source can be attached;
wherein the center position of an aperture opening of said holder-type aperture stop is coincided with the center position of the outside diameter of said holder-type aperture stop; and
wherein the center position of said recess portion is displaced from the center position of the outside diameter of said holder-type lens aperture stop by the distance by which the center position of the outside diameter of the portion of said light-emitting source which is attached to said recess portion is displaced from a light-emitting point.

11. The optical beam scanner as set forth in claim 10,
wherein said lens and said aperture opening are the same in the outer diameter dimension.

12. The optical beam scanner as set forth in claim 2,
wherein said lens is made of resin.

13. The optical beam scanner as set forth in claim 1,
wherein said light deflection mechanism has a prism polygonal mirror as said light deflector and a drive mechanism for rotating said polygonal mirror around its axis.

14. The optical beam scanner as set forth in claim 13,
wherein a light incident on said polygonal mirror is a light beam that focuses on or in the vicinity of said polygonal mirror in a direction perpendicular to the central axis of rotation of said polygonal mirror.

15. The optical beam scanner as set forth in claim 13,
wherein a light incident on said polygonal mirror is a light beam that focuses on or in the vicinity of said polygonal mirror in the directions both perpendicular to and parallel to the central axis of rotation of said polygonal mirror.

16. The optical beam scanner as set forth in claim 1,
wherein said light deflection mechanism has a light deflection disc as said light deflector and a drive mechanism for rotating said light deflection disc;
wherein on a disc surface of said light deflection disc, a plurality of light deflection regions are formed which are divisions in the circumferential direction; and
wherein said plurality of light deflection regions guide the incident light beam in directions different from the direction the adjacent light deflection regions guide the light beam.

17. The optical beam scanner as set forth in claim 16,
wherein said light deflection mechanism has a transmitting light deflection disc as said light deflection disc; and
wherein each of said plurality of light deflection regions has an inclined face which refracts an incident light beam in a direction different from the direction the adjacent light deflection region refracts a light beam so that the incident light beam is guided in a direction different from the direction in which the adjacent light deflection region guides a light beam.

18. The optical beam scanner as set forth in claim 17,
wherein said inclined face is inclined in the radial direction in each of said plurality of light deflection regions, and the angle of inclination of said inclined face is continuously varied in each of said plurality of light deflection regions arranged along the circumferential direction.

19. The optical beam scanner as set forth in claim 17,
wherein said inclined face is inclined in the circumferential direction in each of said plurality of light deflection regions, and the angle of inclination of said inclined face is continuously varied in each of said plurality of light deflection regions arranged along the circumferential direction.

20. The optical beam scanner as set forth in claim 17,
wherein said plurality of light deflection regions are radial divisions in the circumferential direction.

21. The optical beam scanner as set forth in claim 17,
wherein a light incident on said light deflection disc is a light beam that focuses on or in the vicinity of said light deflection disc in the circumferential direction of said light deflection disc.

22. The optical beam scanner as set forth in claim 17,
wherein a light incident on said light deflection disc is a light beam that focuses on or in the vicinity of said light deflection disc in both the circumferential direction and the radial direction of said light deflection disc.

23. The optical beam scanner as set forth in claim 16,
wherein said light deflection mechanism has a reflective light deflection disc as said light deflection disc; and
wherein each of said plurality of light deflection regions has an inclined face that reflects an incident light beam in a direction different from the direction the adjacent light deflection region reflects a light beam, so that an incident light beam can be guided in a direction different from the direction in which the adjacent light deflection region guides a light beam.

24. The optical beam scanner as set forth in claim 23,
wherein said inclined face is inclined in the radial direction in each of said plurality of light deflection regions, and the angle of inclination of said inclined face is varied continuously in each of said plurality of light reflection regions arranged in the circumferential direction.

25. The optical beam scanner as set forth in claim 23,
wherein said inclined face is inclined in the circumferential direction in each of said plurality of light deflection regions, and the angle of inclination of said inclined face is varied continuously in each of said plurality of light reflection regions arranged in the circumferential direction.

26. The optical beam scanner as set forth in claim 23,
wherein said plurality of light deflection regions are radial divisions in the circumferential direction.

27. The optical beam scanner as set forth in claim 23,
wherein a light beam which is incident on said light deflection disc focuses on or in the vicinity of said light deflection disc in the circumferential direction of said light deflection disc.

28. The optical beam scanner as set forth in claim 23,
wherein a light beam incident on said light deflection disc focuses on or in the vicinity of said light deflection disc in both the circumferential direction and the radial direction of said light deflection disc.

29. The optical beam scanner as set forth in claim 1,
wherein said light deflection mechanism has a light deflection disc as said light deflector and a rotation-drive mechanism for rotating said light deflection disc;
wherein said light deflection disc is a transmitting light deflection disc having inclined faces for refracting and guiding an incident light beam on a disc surface thereof; and
wherein said inclined faces have the angles of inclination in the radial direction or in the circumferential direction, which are varied continuously in the circumferential direction.

30. The optical beam scanner as set forth in claim 1,
wherein said light deflection mechanism has a light deflection disc as said light deflector and a rotation-drive mechanism for rotating said light deflection disc;
wherein said light deflection disc is a reflective light deflection disc having inclined faces for refracting and guiding an incident light beam on a disc surface thereof; and
wherein said inclined faces have the angles of inclination in the radial direction or in the circumferential direction, which are varied continuously in the circumferential direction.
